(19) United States
(12) Patent Application Publication
(10) Pub. No.: US 2014/0053694 A1
(43) Pub. Date: Feb. 27, 2014

(54) RIB JOINT PLIERS

(71) Applicant: Li-Tu Lin Wu, Taichung (TW)

(72) Inventor: Li-Tu Lin Wu, Taichung (TW)

(21) Appl. No.: 13/593,828

(22) Filed: Aug. 24, 2012

(51) Int. Cl. B25B 7/06

(52) U.S. Cl. 81/416

(57) ABSTRACT

A pair of rib joint pliers has a first body, a second body and a pivot-adjusting element. The first body has a handle, a jaw and an elongated through slot formed through the first body to form two connecting panels with a mounting recess, a pivot hole and a through hole. The second body is rotatably connected to the first body and has a handle, a jaw and an adjusting groove. The adjusting groove is formed through the second body and communicates with the elongated through slot. The pivot-adjusting element is movably connected to the first body, selectively engages with the second body and has an engaging mount movably mounted between the adjusting groove, the pivot hole and the mounting recess, a pressing button securely connected to the engaging mount and a returning spring mounted in the mounting recess, mounted around the engaging mount and abutting the pressing button.

### BACKGROUND OF THE INVENTION

1. Field of the Invention

The present invention relates to a pair of rib joint pliers, and more particularly to a pair of rib joint pliers to be adjusted and operated conveniently.

2. Description of Related Art

A conventional pair of rib joint pliers is used to clip tubes or pipes and has two bodies, a pivot element and an adjusting retainer. The bodies are pivotally connected to each other by the pivot element, and each body has a jaw and a handle. In addition, one of the bodies has an elongated adjusting groove formed through the body and mounted around the pivot element. The adjusting retainer is connected to the pivot element, is mounted around the bodies and engages the elongated adjusting groove. Furthermore, the adjusting retainer can be an annular plate, a U-shaped frame or a quadrate board.

When the conventional pair of rib joint pliers is in use, the adjusting retainer is pressed to disengage the adjusting retainer from the elongated adjusting groove. Then, the body that has the elongated adjusting groove can be moved relative to the other body by the elongated adjusting groove moving relative to the pivot element to enable the jaws of the bodies to move closer or away from each other. Consequently, the distance between the jaws of the bodies can be adjusted to enable the jaws of the bodies to clip tubes with different diameters. However, the adjusting retainer of the conventional pair of rib joint pliers is mounted outside the bodies and may interfere with or hook around the pipelines, and the adjusting retainer is mounted around the bodies by other components and this will increase the time and cost for manufacturing the conventional pair of rib joint pliers

### SUMMARY OF THE INVENTION

The main objective of the present invention is to provide a pair of rib joint pliers to be adjusted and operated conveniently.

The pair of rib joint pliers in accordance with the present invention has a first body, a second body and a pivot-adjusting element. The first body has a handle, a jaw and an elongated through slot. The elongated through slot is formed through the sides of the first body to form two connecting panels with a mounting recess, a pivot hole and a through hole. The second body is rotatably connected to the first body and has a handle, a jaw and an adjusting groove. The adjusting groove is formed through the second body and communicates with the elongated through slot, the pivot hole and the through hole. The pivot-adjusting element is movably connected to the first body, selectively engages with the second body and has an engaging mount movably mounted between the adjusting groove, the pivot hole and the mounting recess, a pressing button securely connected to the engaging mount and a returning spring mounted in the mounting recess, mounted around the engaging mount and abutting the pressing button.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pair of rib joint pliers in accordance with the present invention;

FIG. 2 is an exploded perspective view of the rib joint pliers in FIG. 1;

FIG. 3 is an enlarged side view in partial section of the rib joint pliers in FIG. 1;

FIG. 4 shows operational side views in partial section of the rib joint pliers in FIG. 3;

FIG. 5 is an operational top view in partial section of the rib joint pliers in FIG. 1; and

FIG. 6 is another perspective view of a pair of rib joint pliers in accordance with the present invention.

### DESCRIPTION OF THE PREFERRED EMBODIMENT

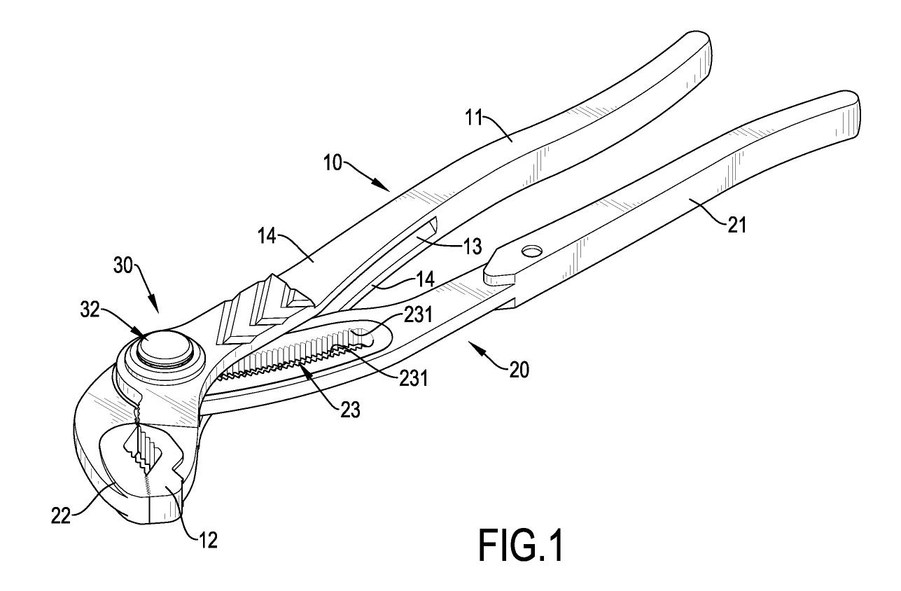

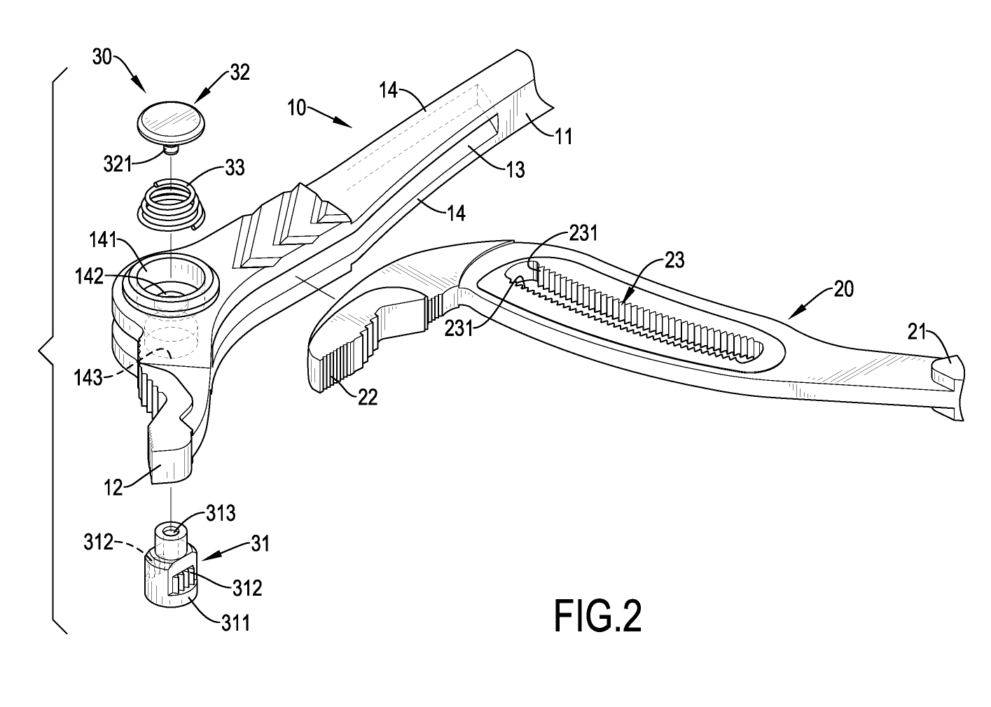

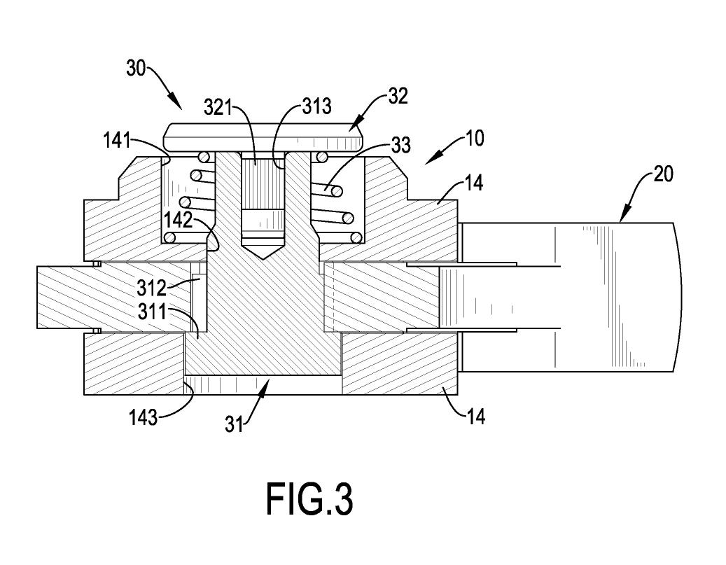

With reference to FIGS. 1 to 3, a pair of rib joint pliers in accordance with the present invention comprises a first body 10, a second body 20 and a pivot-adjusting element 30.

The first body 10 has a front end, a rear end, two sides, a handle 11, a jaw 12 and an elongated through slot 13. The handle 11 is formed on the rear end of the first body 10. The jaw 12 is formed on the front end of the first body 10 and is formed with the handle 11 of the first body 10. The elongated through slot 13 is transversally formed through the sides of the first body 10 near the jaw 12 of the first body 10 to form two connecting panels 14 on the first body 10 at two sides of the elongated through slot 13. The connecting panels 14 are respectively a first connecting panel 14 and a second connecting panel 14.

The first connecting panels 14 has an outer face, an inner face, a mounting recess 141 formed in the outer face of the first connecting panel 14 and a pivot hole 142 formed through the inner face of the first connecting panel 14 and communicating with the mounting recess 141 and the elongated through slot 13. The mounting recess 141 has a diameter larger than a diameter of the pivot hole 142. The second connecting panel 14 has a through hole 143 formed through the second connecting panel 14 and aligning with the pivot hole 142. The through hole 143 has a diameter smaller than the diameter of the mounting recess and larger than the diameter of the pivot hole 142.

The second body 20 is pivotally connected to the first body 10 and has a front end, a rear end, a handle 21, a jaw 22 and an adjusting groove 23. The handle 21 is formed on the rear end of the second body 20. The jaw 22 is formed on the front end of the second body 20, is formed with the handle 21 of the second body 20 and extends through the elongated through slot 13 to face the jaw 12 of the first body 10. The adjusting groove 23 is formed through the second body 20 near the jaw 22 of the second body 20, is located in the elongated through slot 13 between the connecting panels 14 and communicates with the elongated through slot 13, the pivot hole 142 and the through hole 143 of the first body 10. Furthermore, the second body 20 has two racks 231 formed on an inner surface of the second body 20 in the adjusting groove 23 and facing each other.

The pivot-adjusting element 30 is movably connected to the first body 10, selectively engages the second body 20 and has an engaging mount 31, a pressing button 32 and a returning spring 33. The engaging mount 31 is movably mounted in the adjusting groove 23, the pivot hole 142 and the mounting recess 141 via the through hole 143 and has a bottom, a top, two opposite sides, a limiting head 311, multiple engaging teeth 312 and a mounting hole 313. The top of the engaging mount 31 extends in the mounting recess 141 of the first body 10. The opposite sides are flat, are formed on the engaging mount 31 between the top and the bottom of the engaging mount 31 and respectively face the racks 231 in the adjusting groove 23.

The limiting head 311 is formed on and protrudes from the bottom of the engaging mount 31 below the opposite sides of the engaging mount 31 and selectively abuts the second body 20. The engaging teeth 312 are formed on and protrude from the opposite sides of the engaging mount 31 and selectively engage the racks 231 of the second body 20. The mounting hole 313 is axially formed in the top of the engaging mount 31.

The pressing button 32 is securely connected to the top of the engaging mount 31 via the mounting recess 141, covers the mounting recess 141 of the first body 10 and has a bottom face and a mounting rod 321. The mounting rod 321 is formed on and protrudes from the bottom face of the pressing button 32 and is securely mounted in the mounting hole 313 of the engaging mount 31 to securely connect the pressing button 32 with the engaging mount 31. The returning spring 33 is mounted in the mounting recess 141 of the first body 10, is mounted around the engaging mount 31 and abuts the bottom face of the pressing button 32 to enable the limiting head 311 to abut against the second body 20 and to enable the engaging teeth 312 to engage the rack 231 of the second body 20.

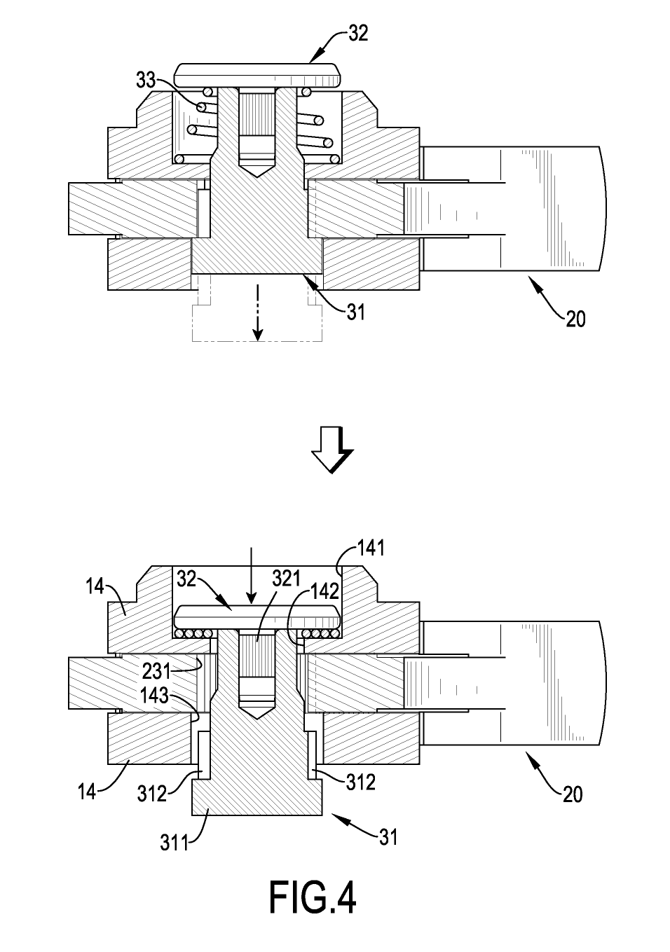

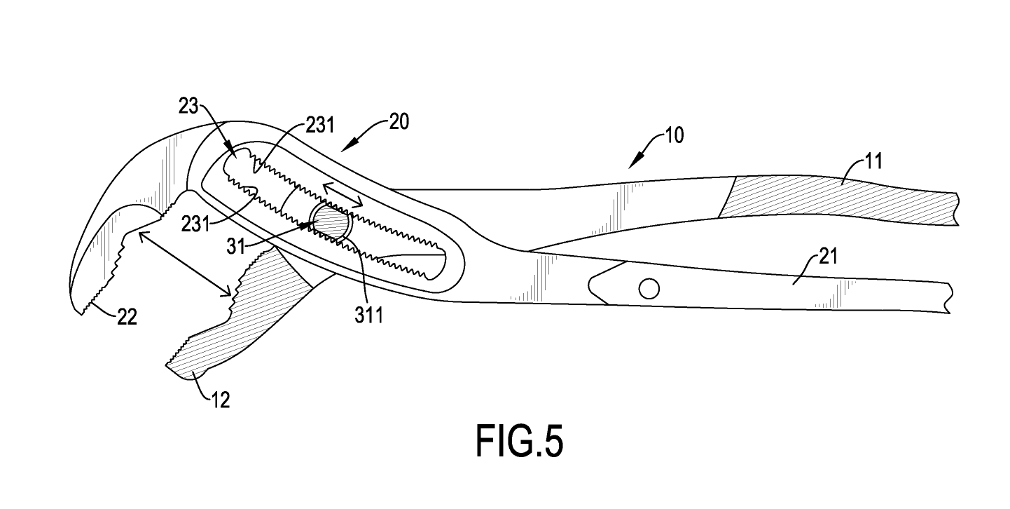

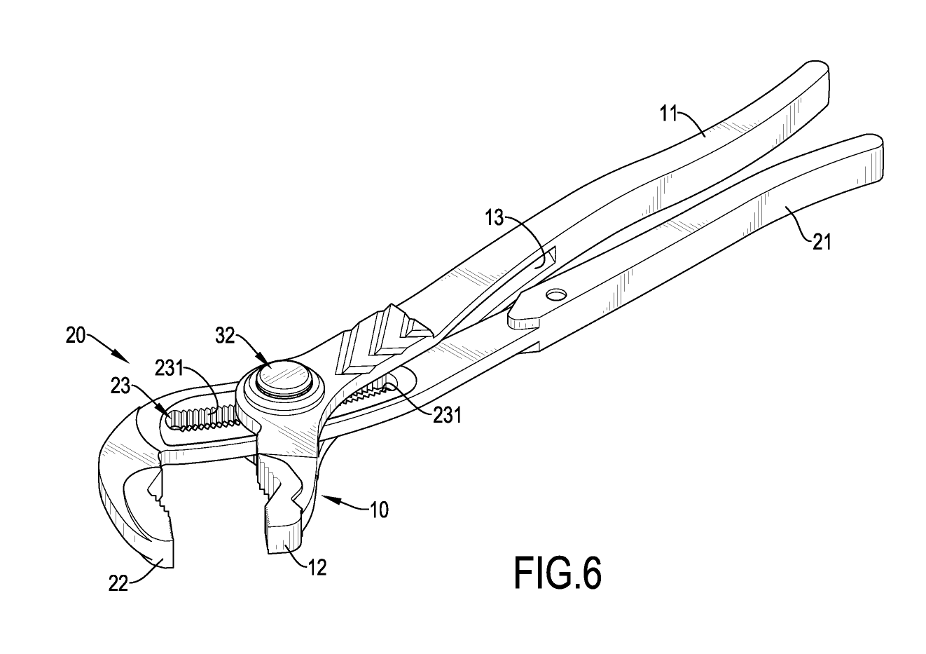

When the pair of rib joint pliers in accordance with the present invention is used to clip tubes with different diameters, with reference to FIG. 4, the pressing button 32 is pressed inwardly into the mounting recess 141 of the first body 10 to compress the returning spring 33. Then, the engaging mount 31 will be pushed by the pressing button 32 and is moved relative to the bodies 10, 20 to disengage the engaging teeth 312 from the racks 231 of the second body 20. Then, with reference to FIGS. 5 and 6, the adjusting groove 23 of the second body 20 can be moved relative to the engaging mount 31 to enable the jaws 12,22 of the bodies 10,20 to move closer or away from each other. Consequently, the distance between the jaws 12, 22 of the bodies 10, 20 can be adjusted to clip tubes with different diameters. After adjusting the distance between the jaws 12, 22, the pressing button 32 is released and an elastic force of the compressed returning spring 33 will push the pressing button 32 to return to the original position, to enable the engaging teeth 312 of the engaging mount 31 to engage the racks 231 of the second body 20 and to enable the limiting head 311 of the engaging mount 31 to abut against the second body 20. Then, the distance between the jaws 12, 22 of the bodies 10, 20 is adjusted to clip tubes conveniently and easily, and connecting position of the bodies 10, 20 is fixed by the engaging teeth 312 of the engaging mount 31 engaging the racks 231 of the second body 20.

According to the above-mentioned pair of rib joint pliers in accordance with the present invention, the distance between the jaws 12, 22 of the bodies 10, 20 can be adjusted conveniently by pressing the pressing button 32 to clip tubes with different diameters. Additionally, the pivot-adjusting element 30 is mounted between the bodies 10, 20 to pivotally connect the second body 20 with the first body 10 and to adjust the distance between the jaws 12, 22 of the bodies 10, 20. Therefore, the pivot-adjusting element 30 can provide a pivot and adjusting effects to the bodies 10, 20, and this can simplify the structures and also can reduce the cost for manufacturing the pair of rib joint pliers in accordance with the present invention. Furthermore, the engaging mount 31, the pressing button 32 and the returning spring 33 of the pivot-adjusting element 30 are mounted in the bodies 10, 20 without exposing out of the bodies 10, 20, and this can prevent the pivot-adjusting element 30 from interfering with or hooking around the pipelines.

Even though numerous characteristics and advantages of the present utility model have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pair of rib joint pliers comprising
a first body having
a front end;
a rear end;
two sides;
a handle formed on the rear end of the first body;
a jaw formed on the front end of the first body and formed with the handle of the first body; and
an elongated through slot transversally formed through the sides of the first body near the jaw of the first body to form two connecting panels on the first body at two sides the elongated through slot, respectively a first connecting panel and a second connecting panel and the first connecting panels having an outer face, an inner face, a mounting recess formed in the outer face of the first connecting panel and a pivot hole formed through the inner face of the first connecting panel and communicating with the mounting recess and the elongated through slot and the second connecting panel having a through hole formed through the second connecting panel and aligning with the pivot hole;
a second body pivotally connected to the first body and having
a front end;
a rear end;
a handle formed on the rear end of the second body;
a jaw formed on the front end of the second body, formed with the handle of the second body and extending through the elongated through slot to face the jaw of the first body;
an adjusting groove formed through the second body near the jaw of the second body, located in the elongated through slot between the connecting panels and communicating with the elongated through slot, the pivot hole and the through hole of the first body; and
two racks formed on an inner surface of the second body in the adjusting groove and facing to each other; and
a pivot-adjusting element movably connected to the first body, selectively engaging the second body and having
an engaging mount movably mounted in the adjusting groove, the pivot hole and the mounting recess via the through hole and having a bottom;
a top extending in the mounting recess of the first body;
two opposite sides being flat, formed on the engaging mount between the top and the bottom of the engaging mount and respectively facing the racks in the adjusting groove;
a limiting head formed on and protruding from the bottom of the engaging mount below the opposite sides of the engaging mount and selectively abutting the second body; and
multiple engaging teeth formed on and protruding from the opposite sides of the engaging mount and selectively engaging the racks of the second body;
a pressing button securely connected to the top of the engaging mount via the mounting recess, covering the mounting recess of the first body and having a bottom face; and
a returning spring mounted in the mounting recess of the first body, mounted around the engaging mount and abutting the bottom face of the pressing button to enable the limiting head to abut against the second body and to enable the engaging teeth to engage the rack of the second body.

2. The pair of rib joint pliers as claimed in claim 1, wherein
the engaging mount has a mounting hole axially formed in the top of the engaging mount; and
the pressing button has a mounting rod formed on and protruding from the bottom face of the pressing button and securely mounted in the mounting hole of the engaging mount to securely connect the pressing button with the engaging mount.

3. The pair of rib joint pliers as claimed in claim 2, wherein
the mounting recess has a diameter larger than a diameter of the pivot hole; and
the through hole has a diameter smaller than the diameter of the mounting recess and larger than the diameter of the pivot hole.

4. The pair of rib joint pliers as claimed in claim 1, wherein
the mounting recess has a diameter larger than a diameter of the pivot hole; and
the through hole has a diameter smaller than the diameter of the mounting recess and larger than the diameter of the pivot hole.
